(19) United States
(12) Patent Application Publication
(10) Pub. No.: US 2025/0210022 A1
(43) Pub. Date: Jun. 26, 2025

(54) ELECTRONIC DEVICE AND CONTROL METHOD THEREOF

(71) Applicant: SAMSUNG ELECTRONICS CO., LTD., Suwon-si (KR)

(72) Inventors: Soohyun WHANG, Suwon-si (KR); Jongpil KIM, Suwon-si (KR); Hyuntae KIM, Suwon-si (KR); Sungdo SON, Suwon-si (KR); Sooyeoun YOON, Suwon-si (KR); Dongho LEE, Suwon-si (KR)

(73) Assignee: SAMSUNG ELECTRONICS CO., LTD., Suwon-si (KR)

(21) Appl. No.: 19/074,842

(22) Filed: Mar. 10, 2025

Related U.S. Application Data
(63) Continuation of application No. PCT/KR2023/014162, filed on Sep. 19, 2023.

(30) Foreign Application Priority Data
Nov. 3, 2022 (KR) 10-2022-0144963

(51) Int. Cl. G10H 1/36

(52) U.S. Cl. CPC G10H 1/368; G10H 2220/101

(57) ABSTRACT

An electronic device comprises: a speaker; a display; a communication device that receives content; and a processor that controls, based on content being received, the speaker to output a sound in association with the content, wherein the processor generates a character user interface (UI) in association with the content based on metadata corresponding to the content, and controls the display so that the generated character UI is displayed.

### CROSS-REFERENCE TO RELATED APPLICATION

This application is a continuation application is a continuation application, under 35 U.S.C. § 111(a), of international application No. PCT/KR2023/014162, filed September 19, 2 023, which claims priority under 35 U. S. C. § 119 to Korean Patent Application No. 10-2022-0144963, filed Nov. 3, 2022, the disclosures of which are incorporated herein by reference in their entireties.

### TECHNICAL FIELD

The disclosure relates to an electronic device and a control method thereof, and more particularly, to an electronic device that can display a character UI corresponding to a content, and a control method thereof.

### BACKGROUND ART

As industries have become highly advanced recently, all electronic devices are changing from analog forms to digital forms, and in the cases of audio devices, digitalization has been rapidly distributed, and improvement of sound quality is being pursued.

Recently, it is not only possible to output a pre-stored content, but also output a content provided by a streaming method. Also, various operations can be performed by using an assistance function, not limited to a use of simply reproducing contents.

### DISCLOSURE

### Technical Solution

Meanwhile, in a computer-readable recording medium including a program for executing a method of displaying a character according to an embodiment of the disclosure, the method of displaying a character may include receiving a content, and generating a character user interface (UI) in association with the content based on metadata corresponding to the content.

In this case, in the generating the character UI, prop contents to be applied to the character UI may be determined by using at least one information among genre information, singer information, and title information included in the metadata, and the character UI may be generated by combining the determined prop contents.

### DESCRIPTION OF DRAWINGS

The aforementioned or other aspects, characters, and advantages of the embodiments of the disclosure will become clearer from the following description with reference to the accompanying drawings. In the accompanying drawings:

FIG. 1 is a diagram illustrating an electronic device according to an embodiment of the disclosure;

FIG. 2 is a diagram illustrating a configuration of an electronic device according to an embodiment of the disclosure;

FIG. 3 is a diagram illustrating a configuration of an electronic device according to an embodiment of the disclosure;

FIG. 4 is a diagram illustrating an example of a UI screen displayed on a display of an electronic device according to an embodiment of the disclosure;

FIG. 5 is a diagram illustrating an example of a UI screen displayed on a display of an electronic device according to an embodiment of the disclosure;

FIG. 6 is a diagram illustrating an example of a UI screen displayed on a display of an electronic device according to an embodiment of the disclosure;

FIG. 7 is a diagram for illustrating an operation according to an arrangement direction of an electronic device according to an embodiment of the disclosure;

FIG. 8 is a diagram for illustrating an operation according to an arrangement direction of an electronic device according to an embodiment of the disclosure;

FIG. 9 is a flow chart for illustrating a control method of an electronic device according to an embodiment of the disclosure; and

FIG. 10 is a flow chart for illustrating a method of displaying a character according to an embodiment of the disclosure.

### MODE FOR INVENTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include various modifications, equivalents, and/or alternatives of the embodiments of the disclosure. Also, with respect to the detailed description of the drawings, similar components may be designated by similar reference numerals.

Also, in describing the disclosure, in case it is determined that detailed explanation of related known functions or features may unnecessarily confuse the gist of the disclosure, the detailed explanation will be omitted.

In addition, the embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Also, the terms used in the disclosure are used only to explain specific embodiments, and are not intended to limit the scope of the disclosure. Further, singular expressions include plural expressions, unless defined obviously differently in the context.

In addition, in the disclosure, expressions such as “have,” “may have,” “include,” and “may include” denote the existence of such characteristics (e.g.: elements such as numbers, functions, operations, and components), and do not exclude the existence of additional characteristics.

Also, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

In addition, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Further, in the embodiments of the disclosure, ‘a module’ or ‘a unit’ may perform at least one function or operation, and may be implemented as hardware or software, or as a combination of hardware and software. Also, a plurality of ‘modules’ or ‘units’ may be integrated into at least one module and implemented as at least one processor, excluding ‘a module’ or ‘a unit’ that needs to be implemented as specific hardware.

Also, operations performed by a module, a program, or other components according to the various embodiments may be executed sequentially, in parallel, repetitively, or heuristically. Or, at least some of the operations may be executed in a different order or omitted, or other operations may be added.

Meanwhile, various elements and areas in the drawings were illustrated schematically. Accordingly, the technical idea of the disclosure is not limited by the relative sizes or intervals illustrated in the accompanying drawings.

Meanwhile, an electronic device according to the various embodiments of the disclosure may include, for example, at least one of a speaker, an AI speaker, a sound bar, a home theater, a set-top box, a smartphone, a tablet PC, a desktop PC, a laptop PC, or a wearable device. A wearable device may include at least one of an accessory-type device (e.g.: a watch, a ring, a bracelet, an ankle bracelet, a necklace, glasses, a contact lens, or a head-mounted-device (HMD)), a device integrated with fabrics or clothing (e.g.: electronic clothing), a body-attached device (e.g.: a skin pad or tattoo), or an implantable circuit.

Also, in some embodiments, an electronic device may include, for example, at least one of a television, a monitor, a projector digital video disk (DVD) player, an audio, a refrigerator, an air conditioner, a cleaner, an oven, a microwave oven, a washing machine, an air purifier, a set-top box, a home automation control panel, a security control panel, a media box (e.g.: Samsung HomeSync™, Apple TV™, or Google TV™), a game console (e.g.: Xbox™, PlayStation™), an electronic dictionary, an electronic key, a camcorder, or an electronic photo frame. Meanwhile, in actual implementation, not only the aforementioned examples, but also a device including a display and a speaker may be the electronic device according to the disclosure.

Hereinafter, the embodiments according to the disclosure will be described in detail with reference to the accompanying drawings, such that those having ordinary skill in the art to which the disclosure belongs can easily carry out the disclosure.

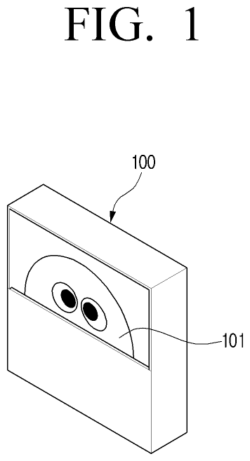

FIG. 1 is a diagram illustrating an electronic device according to an embodiment of the disclosure.

Referring to FIG. 1, an electronic device 100 performs an assistance function. Here, the assistance function is a function that helps a user to perform a desired function even when the user did not input a correct instruction by using an AI technology. Such an assistance function is being applied to various fields such as content reproduction, schedule management, information search, etc.

For example, in the case of wanting to listen to music, previously, a user had to correctly designate music that the user wanted to listen to. However, when the assistance function is used, music corresponding to the taste of music that a user usually listens to can be automatically selected and reproduced.

Such an assistance function may operate based on a user's voice instruction. Previously, when the assistance function was activated, a simple display operation such as emitting light from light emitting diodes was performed.

Accordingly, it was difficult for a user to feel familiar with an electronic device that performs the assistance function.

In the disclosure, a character UI is used so that a user can feel more familiar with an electronic device, and can feel fun interactions in a process wherein the assistance function is performed. Here, a character UI is displayed by imaging a specific character, and it may also be expressed as various terms such as a character icon, a character image, a character thumbnail, etc.

Accordingly, as illustrated in FIG. 1, the electronic device 100 includes a display, and displays a character UI when the assistance function is performed. A displayed character UI may be changed variously by a user, a content that is currently being reproduced, an accessory, etc.

For example, if a user activates the assistance function while listening to classical music by using the electronic device 100, a character UI corresponding to classical music may be displayed. Alternatively, while a user is outputting a content preferred by kids by using the electronic device 100, a character UI preferred by kids may be displayed.

Also, the electronic device 100 may express a character UI 101 to be lively in a process of performing the assistance function. For example, in case the electronic device 100 cannot understand a user's utterance, or could not perform correct voice recognition, the electronic device 100 may display “?” together with the character, or display a character UI having a look of incomprehension. Alternatively, if the electronic device 100 is performing an assistance function related to travel such as reservation of an airline ticket, etc., the electronic device 100 may display a character UI wearing a hat of an airplane captain. Alternatively, while performing an assistance function for proceeding with reservation of a movie ticket, the electronic device 100 may display a character UI corresponding to a specific character of the movie that is currently showing (or the movie that the user wants to reserve a ticket for). However, these features are merely examples, and the electronic device 100 may display various character UIs corresponding to various assistance functions.

Here, change of a character UI may include not only a case wherein the appearance of the character (or an AI character) is changed, but also a case wherein the props worn by the same character, hair, background, skin color, skin state (e.g., sweating, flush, etc.) and the like of the character are changed.

As described above, the electronic device 100 according to the disclosure displays a character UI during the assistance function, and thus it is possible for a user to have a more familiar feeling regarding use of the assistance function.

Meanwhile, in FIG. 1, it was explained that a character UI is displayed only during performing of the assistance function, but a character UI may be displayed not only in a process of performing the assistance function, but also during a basic operation of the electronic device 100.

Meanwhile, in FIG. 1, it was explained that the assistance function is operated through a voice instruction, but in actual implementation, the assistance function may be operated not only through a voice instruction, but also a direct manipulation (e.g., a button manipulation, a text input, a sensor manipulation) of the user, etc., and a user instruction may be input in a form wherein a voice instruction and the aforementioned manipulation are combined.

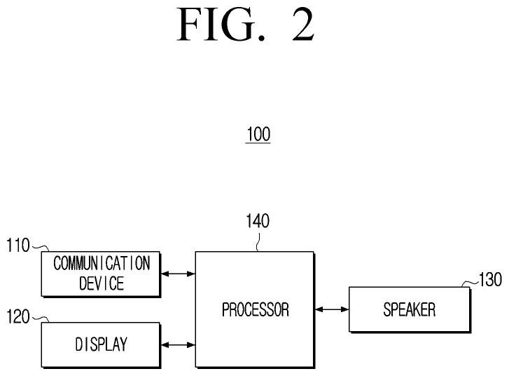

FIG. 2 is a diagram illustrating a configuration of an electronic device according to an embodiment of the disclosure.

Referring to FIG. 2, the electronic device 100 includes a communication device 110, a display 120, a speaker 130, and a processor 140.

The communication device 110 may include at least one circuit, and perform communication with external devices in various types. Such a communication device 110 may be implemented as various interfaces depending on implementation examples. For example, the communication device 110 may include at least one interface among digital interfaces in various types, Wi-Fi based on AP (Wi-Fi, a wireless LAN network), Bluetooth, Zigbee, a wired/wireless local area network (LAN), a wide area network (WAN), Ethernet, near field communication (NFC), and IEEE 1394.

Also, the communication device 110 may include at least one interface among a high definition multimedia interface (HDMI), a mobile high-definition link (MHL), a universal serial bus (USB), a display port (DP), a Thunderbolt, a video graphics array (VGA) port, an RGB port, a D-subminiature (D-SUB), a digital visual interface (DVI), AES/EBU (Audio Engineering Society/European Broadcasting Union), Optical, and Coaxial.

The communication device 110 receives a content. Here, the content may include a music content, a video content, etc. Also, a music content may include metadata having information about the music (data including the singer, the genre, the title of the music, etc.). In addition, a video content may also include detailed information on the content (e.g., the director, the title information, etc.).

Hereinafter, explanation will be described by assuming a case of receiving a content having audio source data. In actual implementation, the content may be a content not including audio source data (e.g., a photo, a text, an e-book, etc.).

The communication device 110 may communicate with an external server, and transmit and receive various types of data for performing the assistance function. For example, the communication device 110 may transmit an audio signal corresponding to an uttered voice of a user or text information wherein the audio signal was converted into a text to an external server. Then, the communication device 110 may receive a response content corresponding to the transmitted information. For example, in case the user uttered a voice such as “Turn the music A,” the communication device 110 may receive a content corresponding to the music A.

Meanwhile, in the case of performing such an operation, an external server that transmitted the aforementioned uttered voice or text and an external server that provides a response content thereto may be different from each other. That is, the external server that transmitted the aforementioned uttered voice or text may be a server that performs a voice recognition function, and the external server that provides a content may be a content provision server.

In case different external servers operate by being interlocked with each other as above, the electronic device 100 may directly receive a content from the content provision server without a separate intervention, or receive a response message from the server performing the voice recognition function, and provide a request message corresponding to the received response message to the content provision server, and receive a content. For example, the external server performing voice recognition may generate a response message which is reproduction of the A music content, and provide the message to the electronic device 100. In this case, the electronic device 100 may request the A music content to the content provision server, and receive the content. Alternatively, the external server performing voice recognition may directly transmit to the content provision server an instruction for providing the A music content to the electronic device 100. In this case, the electronic device 100 may directly receive the A music content.

Also, the communication device 110 may transmit a request for information for performing an instruction corresponding to a voice recognition result. For example, in case the user requested today's weather, the electronic device 100 may recognize that today's weather information should be output, and request information on the today's weather to the external server, and receive the information.

In addition, the communication device 110 may transmit and receive various types of data related to a character UI. For example, a character UI may comprise of character shape data, background data, and prop data (specifically, hair data, eye-related (or glasses) data, skin data), and transmit information requesting data related to the aforementioned shape, background, props, etc. to the external server.

Further, the communication device 110 may transmit and receive information on a relation between the aforementioned various types of data constituting the character UI and a content (e.g., a look-up table). Also, the communication device 110 may transmit information for receiving the aforementioned look-up table from the external server (e.g., the metadata) to the aforementioned external server.

Meanwhile, in actual implementation, the received information may be transmitted as it is, or the information may be transmitted while being processed. For example, by using a deep learning model that extracts only major information among several information included in the metadata, only some information among the several information included in the metadata may be extracted.

Also, in actual implementation, various types of information related to a content may be used other than the metadata, and the information may also be used as it is, or transmitted to the external server while being processed as explained above. In addition, the aforementioned information may include not only the received content information, but also additional information (e.g., information related to the user who views or listens to the current content, the time information, the weather information, etc.).

The display 120 may receive a signal from the processor 140, and display information corresponding to the received signal. For example, the display 120 may be implemented as a display including self-emission elements, or a display including non-self-emission elements and a backlight.

For example, the display 120 may be implemented as displays in various forms such as a liquid crystal display (LCD), an organic light emitting diodes (OLED) display, light emitting diodes (LED), micro LED, mini LED, a plasma display panel (PDP), a quantum dot (QD) display, quantum dot light emitting diodes (QLED), a projector, etc. Inside the display 120, driving circuits that may be implemented in forms such as an a-si TFT, a low temperature poly silicon (LTPS) TFT, an organic TFT (OTFT), etc., and a backlight unit, etc. may also be included. Meanwhile, the display 120 may be implemented as a touch screen combined with a touch sensor, a flexible display, a rollable display, a 3D display, a display wherein a plurality of display modules are physically connected, etc.

Also, the display 120 may display information related to a content. For example, in case the electronic device 100 is reproducing specific music, the display 120 may display a cover image regarding the music. Here, the display 120 may display the image in a photo form, or display the image in a video form such as a form wherein a CD rotates.

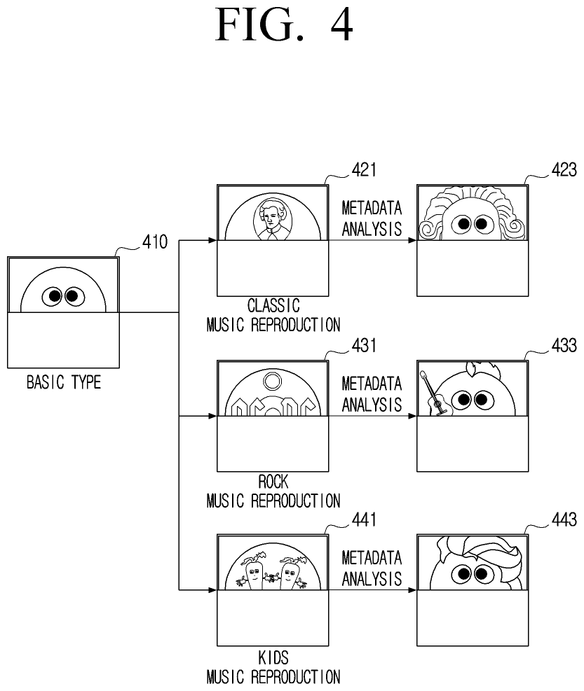

An example of displaying a cover image as above will be described below with reference to FIG. 4. Also, in the case of displaying a video such as a movie, the display 120 may display a poster regarding the video. Such a cover image, a poster, etc., may be included in a received content.

Also, the display 120 may display a character UI. Here, the display 120 may display the aforementioned character UI in a form such as a photo, or display it in a video form wherein a specific part looks as if it is moving. For example, if a character as in FIG. 1 is displayed, a video wherein various facial expressions are made such as blinking eyes, winking, yawning, etc. per specific period may be displayed.

Further, the display 120 may display various types of information corresponding to a user request. For example, in case the user requested weather information through the assistance function, the display 120 may display information related to the weather.

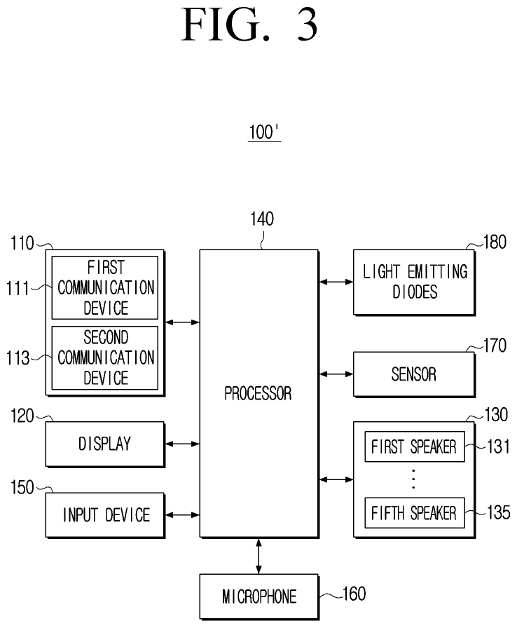

The speaker 130 outputs a sound corresponding to a content. Also, the speaker 130 may output various guide messages or response information corresponding to a received response message as sounds. The speaker 130 may consist of a plurality of speaker units, and explanation in this regard will be described below with reference to FIG. 3.

The processor 140 controls each component of the electronic device 100. Such a processor 140 may consist of memory and a control unit. Such a processor 140 may also be referred to as a control unit, a control device, etc.

The memory may store data necessary for the various embodiments of the disclosure. The memory may be implemented in the form of memory embedded in the electronic device 100, or implemented in the form of memory that can communicate with (or can be attached to or detached from) the electronic device 100 according to the use of stored data.

For example, in the case of data for driving the electronic device 100, the data may be stored in memory embedded in the electronic device 100, and in the case of data for an extended function of the electronic device 100, the data may be stored in memory that can communicate with the electronic device 100. Meanwhile, in the case of memory embedded in the electronic device 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that can communicate with the electronic device 100, the memory may be implemented in forms such as a memory card (e.g., compact flash (CF), secure digital (SD), micro secure digital (Micro-SD), mini secure digital (Mini-SD), extreme digital (xD), a multimedia card (MMC), etc.) and external memory that can be connected to a USB port (e.g., a USB memory), etc.

According to an embodiment, the memory may store at least one instruction or a computer program including instructions for controlling the electronic device 100. Such a computer program may be a program for generating a character UI, a program for voice recognition, a program for performing the assistance function, a program for reproducing a content, etc.

According to another embodiment, the memory may store information on an artificial intelligence model including a plurality of layers. Here, the feature of storing information on an artificial intelligence model may mean storing various types of information related to operations of the artificial intelligence model, e.g., information on a plurality of layers included in the artificial intelligence model, information on parameters (e.g., filter coefficients, biases, etc.) used in each of the plurality of layers, etc. For example, such an artificial intelligence model may be a model for voice recognition or a model for the assistance function.

According to an embodiment, the memory may be implemented as single memory that stores data generated in various operations according to the disclosure. However, according to another embodiment, the memory may be implemented to include a plurality of memories that respectively store various types of data, or respectively store data generated in different steps.

Also, the memory may store data constituting a character UI. Such a character UI may consist of a plurality of layers. For example, each of the plurality of layers may be divided into a character shape, various kinds of props (hair, eyes (glasses or eye shapes), skin (skin color, flush, sweating)), a background, etc., and a plurality of data may be stored for each layer. Accordingly, when displaying a character UI, it is possible to display the character UI in various forms by combining the plurality of layers constituting the current character UI to be displayed.

The control unit is electrically connected with the memory, and controls the overall operations of the electronic device 100. The control unit may consist of one or a plurality of processors. Specifically, the control unit may perform the operations of the electronic device 100 according to the various embodiments of the disclosure by executing the at least one instruction stored in the memory.

According to an embodiment, the processor 140 may be implemented as a digital signal processor (DSP) processing digital image signals, a microprocessor, a graphics processing unit (GPU), an artificial intelligence (AI) processor, a neural processing unit (NPU), and a time controller (T-CON). However, the disclosure is not limited thereto, and the processor 140 may include one or more of a central processing unit (CPU), a micro controller unit (MCU), a micro processing unit (MPU), a controller, an application processor (AP) or a communication processor (CP), and an ARM processor, or may be defined by the terms. Also, the processor 140 may be implemented as a system on chip (SoC) having a processing algorithm stored therein or large scale integration (LSI), or implemented in the form of an application specific integrated circuit (ASIC), or a field programmable gate array (FPGA).

Also, the processor 140 for executing an artificial intelligence model according to an embodiment may be implemented through a combination of a generic-purpose processor such as a CPU, an AP, a digital signal processor (DSP), etc., a graphics-dedicated processor such as a GPU and a vision processing unit (VPU), or an artificial intelligence-dedicated processor such as an NPU and software. The processor 140 may perform control to process input data according to predefined operation rules or an artificial intelligence model stored in the memory. Alternatively, in case the processor 140 is a dedicated processor (or an artificial intelligence-dedicated processor), the processor 140 may be designed as a hardware structure specified for processing of a specific artificial intelligence model. For example, hardware specified for processing of a specific artificial intelligence model may be designed as a hardware chip such as an ASIC, an FPGA, etc. In case the processor 140 is implemented as a dedicated processor, the processor 140 may be implemented to include memory for implementing the embodiments of the disclosure, or implemented to include a memory processing function for using external memory.

When an instruction for activation of the assistance function is input from the user, the processor 140 may perform the assistance function. Such an instruction for activation may be executed in case a button provided on the electronic device 100 was pushed, or a specific utterance keyword (e.g., Hi, Bixby) was input.

Then, when the assistance function is activated, the processor 140 may control the display 120 such that a character UI is displayed, and perform the assistance function. Explanation regarding the assistance function will be described below with reference to FIG. 3.

Specifically, in case a separate content is not being output, the processor 140 may generate a character UI corresponding to a basic character, and control the display 120 such that the generated character UI is displayed. If a specific content is being output, or completion of output of a specific content is within a predetermined time, the processor 140 may control the display 120 to display a character UI corresponding to the content.

For example, in case a music content is being output, or a content that was previously being output is a music content, the processor 140 may generate a character UI corresponding to the metadata by using the metadata. Specifically, the processor 140 may determine prop contents to be applied to the character UI by using genre information, singer information, and title information included in the metadata, and generate a character UI by combining the determined prop contents with the basic character UI. Meanwhile, in actual implementation, prop contents may be determined by using not only the aforementioned information, but also attributes that can express the characteristics that a content has. For example, if a cover image is included in the metadata, and the main attribute of the cover image is a blue color, the skin color of the character UI may be expressed as blue. Alternatively, props reflecting the main characteristics (e.g., the hairstyle, a mustache), etc. inside the cover image may be generated.

Here, the basic character may be a character that the manufacturer initially provided, or a character that was generated based on information received from an accessory device that will be described below. Also, in actual implementation, the basic character may be generated through an accessory device, or may be one of a plurality of character shapes selected by the user.

For example, in case the basic character is a circular face image as in FIG. 1, the processor 140 may generate a character UI by synthesizing several props corresponding to the genre onto the face image, corresponding to the basic character with the face shape.

Also, the processor 140 may generate a character UI by reflecting various props, not only the ones corresponding to the background of the character UI and/or the aforementioned metadata, but also other props, in addition to the basic ones. For example, it is possible to generate a character UI by various methods such as, in case a case accessory mounted by the user is a red color, correcting the face shape to have a red color, or changing the background color to correspond to the current weather/time/temperature, etc., or reflecting props regarding the background (e.g., raindrops, snow), etc.

In addition, the processor 140 may also perform the aforementioned operation for a video content which is not a music content. Specifically, the processor 140 may generate a character UI by using the director information, the content name, etc. by using content information included in the video content. For example, in case a specific movie is a movie having a medieval background, the processor 140 may generate a character UI that has a medieval background and a sword as a prop.

Also, the processor 140 may generate a character UI correspondingly to a content that is being reproduced in another device which is not a content that is being reproduced in the electronic device 100. Specifically, in case a movie is being reproduced in a display device such as a TV in a home network, the processor 140 may receive information on the movie that is being reproduced in the display device through the communication device 110, and display a character UI corresponding to the received movie information.

Meanwhile, in case prop contents necessary for expressing the information on the content described above are not stored in the electronic device 100, or prop contents necessary for displaying the content cannot be identified, the processor 140 may use the external server. Specifically, as described above, the processor 140 may transmit content information identified through the metadata to the external server, or transmit the metadata itself to the external server, and identify prop contents corresponding to the content. Also, if the identified prop contents are not stored in the electronic device 100, the processor 140 may request the prop contents to an external device, and receive them.

Meanwhile, the processor 140 may perform an authentication operation in a process of transmitting and receiving the prop contents described above. For example, in case a copyright exists for a specific prop content (or a background content), etc., or purchase is needed, the processor 140 may identify whether the user of the electronic device 100 has authority for the prop content, etc., and receive the prop content in case authority has been identified. Meanwhile, in actual implementation, it may be determined whether a prop content can be received by using authority of a content that is currently used by the user instead of authority for the prop content itself. For example, in case the user purchased a specific movie, and has use authority for use of a prop content corresponding to the movie, it may be determined whether the prop content can be received by identifying user authority for the movie when receiving the prop content for the movie. Regarding such determination, it is possible that user authority information is transmitted to an external server, and the external server makes determination, and it is also possible that the electronic device 100 makes determination by using DRM information, etc. set for a content.

Also, the processor 140 may set or change a guide voice mode (or a voice) that is used while performing the assistance function. Specifically, in case a character UI is changed through the aforementioned process, a guide voice mode corresponding to the generated character UI among a plurality of guide voice modes may be determined. For example, if it was set in advance that a guide voice will be output in an adult male voice, and a kids content is reproduced and a character UI corresponding to the kids content is displayed, the processor 140 may change the mode of the guide voice to a kids mode in a corresponding manner thereto, and output a guide message or a response message in a voice corresponding to the changed kids mode.

For this, the electronic device 100 may have a plurality of guide voice modes, and store audio source data corresponding to each of the guide voice modes. In case audio source data corresponding to the changed character UI is not stored, the processor 140 may control the communication device 110 to request corresponding audio source data to an external device and receive the data. A guide voice mode may simply be a voice divided into an adult male, an adult female, and a kid, or an audio source corresponding to a specific person, or a voice corresponding to a character in a movie/a series.

Also, when the processor 140 receives a content, the processor 140 may control the speaker 130 such that a sound corresponding to the received content is output. In addition, the processor 140 may control the speaker 130 to output various guide messages or response messages corresponding to the assistance function.

Further, the processor 140 may control the display 120 such that information corresponding to a content is displayed at the time of a basic operation of the electronic device 100. For example, in case a music content is being reproduced, the processor 140 may control the display 120 such that a cover image of the music that is currently being reproduced is displayed. Meanwhile, if the assistance function is activated during such an operation, the processor 140 may control the display 120 such that a character UI corresponding to the content is displayed as explained above.

Also, before performing the aforementioned display operation of the character UI faster, the processor 140 may perform in advance an operation of generating a character UI corresponding to a content that is being reproduced while reproducing the content, or identifying whether data necessary for generating the character UI exists, or receiving such data.

As described above, the electronic device 100 according to the disclosure displays various character UIs correspondingly to a content that is currently being reproduced, and thus it is possible for the user to use the electronic device in a more friendly way. Also, as a character UI is changed variously according to the genre of a content that is being reproduced, etc., a fun interaction experience can be provided.

Meanwhile, in FIG. 2, only simple components of the electronic device 100 were illustrated, but the electronic device 100 may further include various components that were not illustrated in FIG. 2. Explanation in this regard will be described below with reference to FIG. 3.

FIG. 3 is a diagram illustrating a configuration of an electronic device according to an embodiment of the disclosure.

Referring to FIG. 3, the electronic device 100 includes a communication device 110, a display 120, a speaker 130, a processor 140, an input device 150, a microphone 160, a sensor 170, and light emitting diodes 180.

As basic explanation regarding the communication device 110, the display 120, the speaker 130, and the processor 140 was described in FIG. 2, only contents related to additional operations not explained in FIG. 2 will be explained below.

The communication device 110 includes a plurality of communication devices 111, 113. Specifically, the communication device 110 may include a first communication device 111 and a second communication device 113 that operate by different communication methods. Meanwhile, in actual implementation, the communication device 110 may include three or more communication devices.

The first communication device 111 is a communication device connected with an external Internet network, and it may be a device such as Wi-Fi, etc., and may perform the same function as the communication device 110 in FIG. 2.

The second communication device 113 is a communication device that performs near field communication, and it may be NFC, etc. Specifically, the second communication device 113 may be arranged to be adjacent to the exterior of the electronic device 100, and receive information on an external device (or information provided by an external device) from the external device. Such a second communication device 113 may be arranged in the upper end area of the electronic device 100. Accordingly, when a case accessory of the electronic device 100 is mounted, the second communication device 113 may receive device information of the mounted case accessory.

Also, the second communication device 113 may receive not only the device information of the mounted case accessory, but also content information from a user terminal device. For example, while the user is listening to music through a user terminal device, an operation of tagging the upper end of the electronic device 100 (i.e., the area wherein the second communication device 113 is located) may be performed. In this case, the processor 140 may receive information on the content that is being reproduced in the user terminal device through the second communication device 113, and reproduce a content corresponding to the received content information.

The speaker 130 may output a sound corresponding to a content, or output a guide message or a response message corresponding to the assistance function. Such a speaker 130 may consist of a plurality of speaker units 131-135. The speaker 130 may include a first speaker unit 131 arranged on the upper end of the main body of the electronic device, a second speaker unit 132 arranged on the left side surface of the main body, a third speaker unit 133 arranged on the right side surface of the main body, a fourth speaker unit 134 arranged on the front surface of the main body, and a fifth speaker unit 135 arranged on the bottom surface of the main body. Meanwhile, in the illustrated example, it was illustrated and explained that the speaker 130 includes five speaker units, but in actual implementation, the speaker 130 may include four or fewer speaker units, or include six or more speaker units.

In case the speaker 130 includes a plurality of speaker units as above, the processor 140 may identify the arrangement structure of the electronic device 100 based on a sensor value detected at the sensor 170 that will be described below, and control the plurality of speakers such that output of a sound according to the identified arrangement structure is performed.

For example, in case the electronic device 100 is arranged as in FIG. 1, it is difficult for the fifth speaker unit 135 to output a sound as it contacts the bottom surface. Accordingly, the processor 140 may make only the remaining four speaker units 131, 132, 133, 134 excluding the fifth speaker unit 135 operate. Here, the processor 140 may make a corresponding channel among a plurality of channels constituting an audio source output in consideration of the arrangement locations of each speaker unit. For example, in the case of FIG. 1, the processor 140 may make the second speaker unit 132 output the left channel of the audio source, and make the third speaker unit 133 output the right channel, and make the first speaker unit 131 and the fourth speaker unit 134 to output the center channel. As described above, it is possible for the electronic device 100 according to the disclosure to output a sound more stereoscopically by using the plurality of speaker units.

Meanwhile, in actual implementation, the electronic device 100 may operate while being held on a holder. As the fifth speaker unit 135 as above does not contact the bottom surface, the fifth speaker unit 135 may also output a sound. For this, the processor 140 may identify whether the electronic device 100 is held on a holder, and in case the electronic device 100 is held on a holder, all of the five speaker units may output a sound. In actual implementation, it may be identified whether the electronic device 100 is held on a holder by various methods such as getting confirmation about the held state from the user, detecting whether a protruding element is put into the rear surface of the electronic device 100, or arranging an NFC tag on the holder and receiving NFC information including information on the holder, etc.

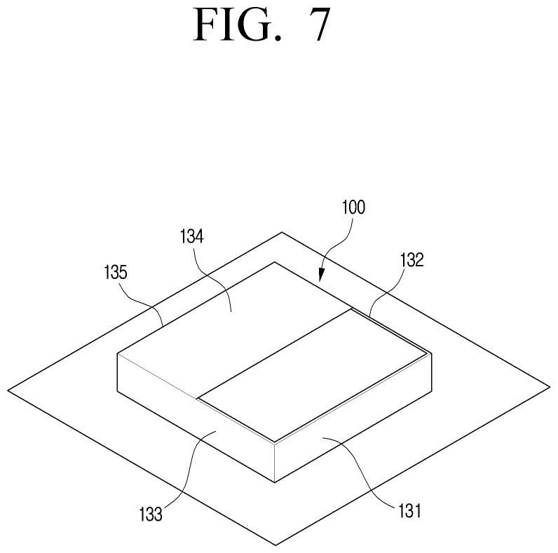

Also, for example, in case the electronic device 100 is arranged as in FIG. 7, the processor 140 may make the five speakers operate as omnidirectional speakers in 360 degrees.

The input device 150 is a device for receiving an input of a user's control instruction, and it may consist of a button. Alternatively, the input device 150 may be implemented as a touch screen that performs the function of the display 120 together. Meanwhile, the aforementioned button may receive inputs of a plurality of functions according to the user's manipulation. For example, if the button received a short input once, the button may alternatingly receive an input of temporary pause or reproduction of a content, and if the button received short inputs twice, the inputs may be a change to the next content, etc. Alternatively, if the button receives a short input once, it may operate for activation of the assistance function, and if the button receives a long input, it may operate for a power off operation.

Also, the input device 150 may include a button in a form of a protruding element arranged on the rear surface of the electronic device 100. The processor 140 may determine whether the electronic device 100 is mounted on a holder based on the protruding state of the protruding element. For example, if a state wherein the protruding element was put in and the button was pushed is detected, the processor 140 may determine that the electronic device 100 is mounted on a holder.

The microphone 160 is a component for receiving inputs of a user voice or other sounds, and converting them into audio data. The processor 140 may perform the assistance function by using a user voice input through the microphone 160. Also, the microphone 160 may be constituted as a stereo microphone that receives inputs of sounds in a plurality of locations.

The sensor 170 may be executed for use in detecting the arrangement state of the electronic device 100. For example, the sensor 170 may be a gyro sensor. Meanwhile, in actual implementation, the sensor 170 may be executed as a combination of a gyro sensor and a geomagnetic sensor, etc. Also, the sensor 170 may further include a GPS sensor, an illumination sensor, etc. other than the aforementioned gyro sensor, and identify information on the location wherein the electronic device 100 is located or the ambient environment information, etc.

Accordingly, the processor 140 may identify the arrangement form of the electronic device 100 by using a measurement value received from the sensor 170, and control the plurality of speakers 170 correspondingly to the identified arrangement form.

The light emitting diodes 180 may emit light. For example, in case the voice recognition process (or the assistance function) was activated, or preparation for receiving an uttered voice of the user through the microphone 160 was made, the processor 140 may make the light emitting diodes 180 emit light. Here, the processor 140 may perform an operation of displaying a character UI together as explained above.

Also, the processor 140 may control the light emitting diodes 180 to emit light corresponding to a state according to the state of the electronic device 100 other than the aforementioned operation. For example, during a normal operation, the processor 140 may control the light emitting diodes 180 such that a green light is displayed, and in a situation wherein charging is needed as the remaining amount of the battery is low or a situation wherein an error occurred (e.g., in case the electronic device 100 is not connected to an Internet network, etc.), the processor 140 may control the light emitting diodes 180 to be displayed in a red color. Also, during voice recognition or during processing of an uttered voice of the user, the processor 140 may control the light emitting diodes 180 such that the light emitting diodes 180 flicker so as to display that voice recognition is proceeding.

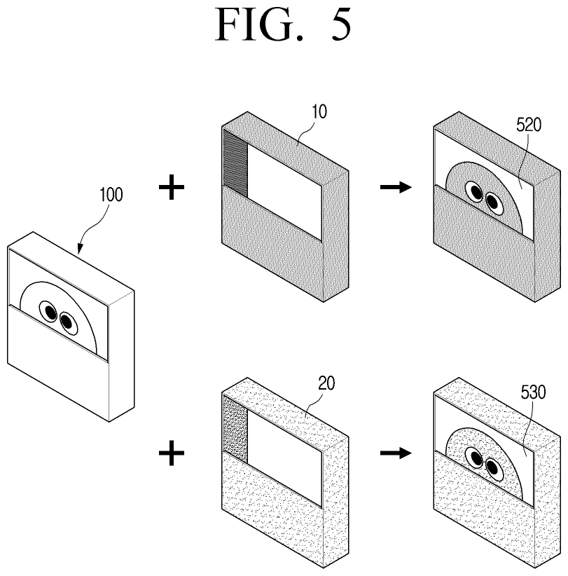

Meanwhile, in FIG. 5, it was illustrated and explained that the electronic device 100 includes various components. However, in actual implementation, the electronic device 100 may further include other components (e.g., a battery, a camera, etc.) not illustrated in FIG. 5, or may have a form wherein some of the aforementioned components are omitted.

Meanwhile, in illustrating and explaining FIG. 1 to FIG. 3, it was explained that the assistance function operates in case an instruction for activation of the assistance function is input from the user, but in actual implementation, the assistance function may operate not only in the aforementioned case, but also in various situations. For example, the assistance function may be performed according to various event situations in the electronic device, such as starting on a time that was set by the user in advance, or starting on a time point when reproduction of all music in the play list was completed, etc.

Also, the assistance function may be performed correspondingly to not only an event situation in the electronic device, but also a change of an external situation. For example, the aforementioned assistance function may be performed based on information provided from an IoT device in a home network (e.g., a situation wherein heating is needed as the temperature is low, a situation wherein cooling is needed as the temperature is high, a situation wherein an operation of the air purifier is needed as there is a lot of dust).

When an instruction for activation of the assistance function is input from the user,

FIG. 4 is a diagram illustrating an example of a UI screen displayed on a display of an electronic device according to an embodiment of the disclosure. Specifically, FIG. 4 is a diagram illustrating various examples of a character UI displayed according to various contents.

First, in case a content is not being reproduced currently, the electronic device 100 may display a basic character UI 420. Such a basic character may be a character that was initially provided by the manufacturer. In case the user mounted an accessary case as explained in FIG. 5 that will be described below, or changed the basic character shape by a download method, the character UI that is currently set may be displayed.

Here, the electronic device 100 may, based on various kinds of information such as the weather/time/temperature, etc., display a character UI corresponding to the weather/time/temperature. For example, on a rainy day, the electronic device 100 may display rain in the background of the character UI, and on a snowy day, the electronic device 100 may display snow in the background of the character UI. Alternatively, on a hot day, the electronic device 100 may display sweat on the skin of the character UI, and on a cold day, the electronic device 100 may display a shape of the character UI shivering with cold. Alternatively, in the evening time, the electronic device 100 may display a sunset as the background, and at late night, the electronic device 100 may display a background having a night sky.

In such a state, if the user requests reproduction of a content, the electronic device 100 may output a sound corresponding to the content. Then, the electronic device 100 may display information corresponding to the content as images 421, 431, 441. In the illustrated example, it was illustrated that an album cover image included in a music content is displayed, but in actual implementation, information on an album but not an album cover image may be displayed. Also, in the illustrated example, the cover image was displayed in a semicircle shape, but this is for displaying a shape that looks as if the electronic device 100 reproduces a CD, and in actual implementation, it is also possible to display the cover image in a different shape other than the aforementioned shape.

If the user activates the assistance function while reproducing a content as above, a character UI corresponding to the content that is currently being reproduced is displayed. For example, if the assistance function is activated during reproduction of classical music 421, a character UI 423 corresponding to classical music (a character UI having a hairstyle in a classical form as illustrated) may be displayed.

Also, if the content reproduced is rock music 431, a character UI 433 to which a guitar prop corresponding to rock music is reflected may be displayed. Also, if the content reproduced is music liked by kids 441, a character UI 443 to which a prop advantageous for identifying the content reproduced is reflected may be displayed.

Meanwhile, in the above, it was explained that only a content UI is changed correspondingly to a content reproduced, but in actual implementation, a voice mode (specifically, a voice) outputting a guide message or a response message may also be changed. For example, while a classical content is being reproduced, a guide message, etc. may be output in a classical voice, and in case music for kids is being reproduced, a guide message, etc. may be output in a kid's voice (or a character's voice corresponding to the content that is currently being reproduced).

Meanwhile, in FIG. 4, it was illustrated and explained that, in case a specific content is being reproduced, if the assistance function is activated, a character UI corresponding to the content is displayed. However, in actual implementation, even in case a content is not being reproduced, if the assistance function is activated, a character UI corresponding to a content may be displayed. For example, in case the assistance function was activated within a predetermined time after completion of reproduction, a character UI corresponding to a content that was output within the predetermined time may be displayed, or a character UI corresponding to a content that was recently output regardless of time may be displayed. Alternatively, it is also possible to select a content for which the user's reproduction frequency is high, and display a character UI corresponding to the selected content.

Meanwhile, in FIG. 4, it was illustrated that in displaying a character UI, only a part of the appearance of the character (specifically, a face in a semicircle shape) is displayed. This is for the same reason as displaying an album image like a CD shape when displaying content information, and is for displaying a character UI in the same shape. Accordingly, in case the shape or the size, etc. of the display in the electronic device are different from FIG. 4, the size, etc. shown in the displayed character UI may also be changed in accordance thereto.

FIG. 5 is a diagram illustrating an example of a UI screen displayed on a display of an electronic device according to an embodiment of the disclosure. Specifically, FIG. 5 explains an operation in case an accessory device is mounted on the electronic device.

For example, the accessory devices 10, 20 may be cases enclosing the exterior of the electronic device 100. Such accessory devices 10, 20 may include an NFC tag, and the NFC tag may be located in an area corresponding to an area wherein an NFC recognition device of the electronic device 100 is located. For example, in case the NFC recognition device is located on the upper end of the electronic device 100, the NFC tag may be located in the upper end areas of the accessary devices 10, 20.

Meanwhile, the electronic device 100 according to the disclosure includes a plurality of speakers. Accordingly, in case the speakers are enclosed by the accessory devices, output of a sound may be interfered by the accessory devices. Accordingly, in the accessory devices in case forms, a surface corresponding to an area wherein the speaker of the electronic device 100 is arranged may include a plurality of holes, and a sound output from the electronic device 100 may thereby be made to be output well.

In case the accessory devices 10, 20 are mounted on the electronic device 100 as above, the electronic device 100 may recognize that the accessory devices 10, 20 were mounted. Then, the electronic device 100 may change the character UI to correspond to the mounted accessory devices 10, 20.

For example, if the first accessory device 10 is a red case, the electronic device 100 may generate a character UI 520 wherein the skin color of the character inside the character UI is red, and display the UI.

Alternatively, if the second accessory device 20 is a yellow case, the electronic device 100 may generate a character UI wherein the skin color of the character inside the character UI is yellow, and display the UI.

Meanwhile, in the above, it was illustrated that the skin color of a character is changed according to the color of an accessory device, but in actual implementation, the background color of a character UI may also be changed.

Also, the personality of a mounted character may be changed according to the type of a mounted accessory device. For example, in case a case of a calm color is mounted, the character may be set in a form having a calm personality or a voice guide message may be set in a calm voice. In contrast, if a case of a warm color such as red is mounted, the voice may be set as a lively personality.

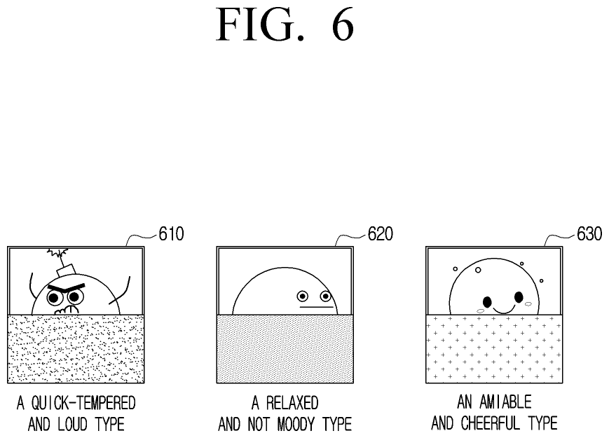

Meanwhile, in FIG. 5, it was illustrated and explained that only the skin color or the background, the voice, etc. of a character are changed based on a mounted accessory device, but in actual implementation, the shape or a prop, etc. of a character may also be changed. Explanation in this regard will be described in FIG. 6.

FIG. 6 is a diagram illustrating an example of a change of a UI screen displayed on a display of an electronic device by an accessory.

Referring to FIG. 6, it is a diagram illustrating appearances of various characters 610, 620, 630 corresponding to accessory devices.

Referring to the drawing, the appearance of a character may be changed according to a change of the case. Also, according to the changed appearance, the character (or the voice) of the character may be changed.

Meanwhile, in actual implementation, not only a circle character, but also various characters that are already known may be displayed. For example, in case an accessary case is an accessory related to a specific movie, the main character of the movie may be used as a character UI, and when the case is mounted, the voice of the character may be applied to a voice guide message, etc.

Also, in case an accessary case is a case related to a specific product or a specific company, a character UI corresponding to the product or the company CI of the company may be displayed. For example, in case a case having a shape of a specific chocolate bar is mounted, the main character of the chocolate bar may be displayed as the character UI.

FIG. 7 is a diagram for illustrating an operation of an electronic device according to an embodiment of the disclosure.

Specifically, FIG. 7 illustrates a case wherein the rear surface of the electronic device is placed to contact the bottom. As explained in FIG. 3 above, the electronic device may include a plurality of speakers, and the plurality of speakers may be arranged on the various surfaces of the electronic device.

Accordingly, in case the bottom surface is placed on the bottom as in FIG. 1, the electronic device may make the fifth speaker unit 135 placed on the bottom surface not output a sound, and make the left speaker output a sound corresponding to the left channel, and make the right speaker output a sound corresponding to the right channel, and make the speakers on the front surface and the upper part output sounds corresponding to the center channel.

In case the rear surface is placed on the bottom as illustrated in FIG. 7, the electronic device may make the plurality of speakers operate as omnidirectional speakers in 360 degrees.

Here, the display 120 may display a character in a shape as in FIG. 1, or display a lying character. That is, the electronic device 100 may display a character UI in a direction corresponding to not only channels output by each speaker, but also the arrangement form according to the arrangement form of the electronic device 100.

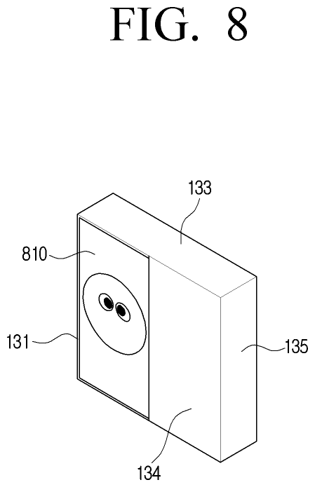

FIG. 8 is a diagram for illustrating an operation of an electronic device according to an embodiment of the disclosure.

Specifically, FIG. 8 illustrates a case wherein the left side surface of the electronic device 100 is placed to contact the bottom. In case the left side surface of the electronic device 100 contacts the bottom as above, the electronic device 100 may output a sound of the left channel by using the first speaker unit 131 (the speaker on the upper side), and output a sound of the right channel by using the fifth speaker unit 135 (the speaker on the lower side).

As described above, the electronic device 100 according to the disclosure may change a sound channel output by a speaker to correspond to the arrangement form, and output the sound.

In addition, when compared with FIG. 1, it can be identified that the shape of a displayed character is also changed. Meanwhile, in the illustrated example, it was illustrated that the shape of the character is displayed to be all the same, but in actual implementation, it is also possible to display only a half of the character in the same manner as in FIG. 1, and in such a case, a character UI having a character shape that has only one eye and a half of a mouth may be displayed.

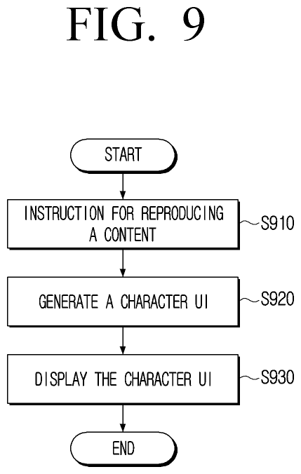

FIG. 9 is a flow chart for illustrating a control method of an electronic device according to an embodiment of the disclosure.

Referring to FIG. 9, if an instruction for reproducing a content is input in the operation S910, a sound corresponding to the content is output. Here, the content may be a music content, or a video content such as a movie, broadcasting, etc. Also, such a content includes not only a content of the electronic device 100 itself, but also output of a content at another device in a home network. For example, the electronic device 100 may also operate in case a movie is being reproduced at a display device such as a TV located in the home network. Here, it is also possible for the electronic device 100 to receive audio source data of the content, and output it. For example, in case the electronic device 100 is a home theater or a sound bar, etc., the electronic device 100 may receive audio source data from the display device, and output it.

Then, a character UI corresponding to the content is generated by using metadata corresponding to the content in the operation S920. Specifically, prop contents to be applied to a character UI may be determined by using genre information, singer information, and title information included in the metadata, and the character UI may be generated by combining the determined prop contents. For example, the metadata may be transmitted to an external server, and character UI data corresponding to the metadata may be received from the external server, and the character UI may be generated by using the received character UI data. Alternatively, information on the determined prop contents may be transmitted to an external server, and prop contents data corresponding to the information on the prop contents may be received from the external server, and the character UI may be generated.

Meanwhile, the aforementioned character shape may correspond to information on an accessory device mounted on the electronic device 100, and if a separate accessory device was not mounted, the character may have a basic character shape. Also, in actual implementation, not only an accessory device but also data in a form that was selected and downloaded in advance by the user may be used for the character shape.

Then, the generated character UI is displayed in the operation S930. Meanwhile, in actual implementation, the generated character UI may not be displayed by the electronic device 100, but may be implemented in a form of being displayed by another device. For example, in case the electronic device 100 is implemented as a set-top box or a device not including a display, the electronic device 100 may make the character UI displayed at another device including a display in the home network (e.g., a TV, a refrigerator having a large size display, etc.).

Meanwhile, if the assistance function is performed while a character UI is displayed as described above, a guide message or a response message may be output in a voice corresponding to the character UI. Specifically, a guide voice mode corresponding to the generated character UI among the plurality of guide voice modes may be determined and set, and when a guide message output event occurs, a guide message may be output in a voice corresponding to the determined guide voice mode. For example, if the assistance function is activated while a fairy tale content is being output, the electronic device 100 may recognize the mode as a kids mode, and a guide message or a response message may be output in a kid's voice corresponding to the kids mode.

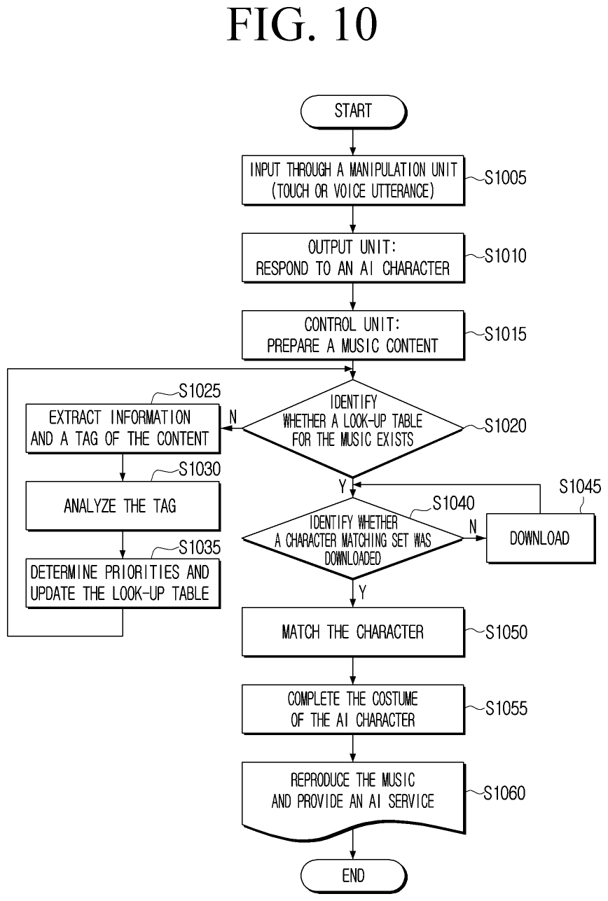

FIG. 10 is a flow chart for illustrating a method of displaying a character according to an embodiment of the disclosure.

Referring to FIG. 10, a user instruction is input in the operation S1005. Specifically, such a user instruction may be input through a button provided on the electronic device 100, or input through a specific trigger voice (e.g., Hi, Bixby). Also, such a user instruction is for inputting a voice instruction, and it may be, for example, for activation of the assistance function.

If the assistance function is activated as above, a character UI may be displayed in the operation S1010. The displayed character may be a default character, and may be a character UI corresponding to a content that was being reproduced right before or a content that is currently paused temporarily.

If the aforementioned assistance function is reproduction of a specific content, receipt of a content requested by the user may be requested to an external server in the operation S1015.

Then, it may be identified whether a look-up table corresponding to the received content exists in the operation S1020. Here, the look-up data is information that defined the relation between the content and the character UI, and in the illustrated example, it was illustrated that the electronic device 100 identifies the relation by itself, but in actual implementation, the electronic device 100 may perform the aforementioned operation by transmitting the metadata to an external server, and receiving a look-up table corresponding to the transmitted metadata.

In case a look-up table does not exist in the operation S1020-N, tags may be extracted from the metadata in the operation S1025 and analyzed in the operation S1030, and look-up data may be generated by determining the priorities corresponding to each tag in the operation S1035.

Then, it may be identified whether a character matching set exists based on the look-up table in the operation S1040. In case data of necessary props does not exist, the aforementioned prop data may be requested to the external server and received in the operation S1045. Meanwhile, in actual implementation, the aforementioned operations of comparing the look-up table and downloading may be performed simultaneously through the operation of transmitting the metadata to the external server as explained above. That is, the electronic device 100 may be implemented in a form of transmitting the metadata to the external server, and receiving prop data corresponding to the metadata from the external server.

When all data is prepared as above, a character UI may be generated in the steps S1050 and S1055, and the generated character UI may be displayed in the operation S1060.

Meanwhile, in the illustrated example, it was illustrated and explained that music is reproduced at the same time as generation of the character UI, but in actual implementation, it is also possible to reproduce music in advance, and display the character UI later. Also, in case a content is currently being reproduced, tasks such as making a character UI corresponding to the content that is currently being reproduced in advance before activation of the assistance function, or receiving prop data necessary for generating the character UI from an external server in advance, etc. may be performed.

Meanwhile, methods according to at least some of the aforementioned various embodiments of the disclosure may be implemented in forms of applications that can be installed on conventional electronic devices.

Also, the methods according to at least some of the aforementioned various embodiments of the disclosure may be implemented just with software upgrade, or hardware upgrade of conventional electronic devices.

In addition, the methods according to at least some of the aforementioned various embodiments of the disclosure may be performed through an embedded server provided on an electronic device, or an external server of an electronic device.

Meanwhile, according to an embodiment of the disclosure, the aforementioned various embodiments may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: an electronic device A). In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘a non-transitory storage medium’ only means that the storage medium is a tangible device, and does not include signals (e.g.: electromagnetic waves), and the term does not distinguish a case wherein data is stored in the storage medium semi-permanently and a case wherein data is stored in the storage medium temporarily. For example, ‘a non-transitory storage medium’ may include a buffer wherein data is temporarily stored. Also, according to an embodiment, the methods according to the various embodiments disclosed herein may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or can be distributed directly between two user devices (e.g.: smartphones), and distributed on-line (e.g.: download or upload) through an application store (e.g.: Play Store™). In the case of on-line distribution, at least a portion of a computer program product (e.g.: a downloadable app) may be stored in a storage medium which can be read by machines such as the server of the manufacturer, the server of the application store, and the memory of the relay server at least temporarily, or may be generated temporarily.

The various embodiments of the disclosure may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: an electronic device A).

In case an instruction is executed by a processor, the processor may perform a function corresponding to the instruction by itself, or by using other components under its control. An instruction may include a code that is generated or executed by a compiler or an interpreter.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

1. An electronic device comprising:
a speaker;
a display;
a communication device to receive a content; and
a processor which, based on receiving the content, controls the speaker to output a sound in association with the content,
wherein the processor is configured to:
generate a character user interface (UI) in association with the content based on metadata corresponding to the content, and control the display such that the generated character UI is displayed.

2. The electronic device of claim 1,
wherein the processor is configured to:
determine prop contents to be applied to the character UI by using at least one information among genre information, singer information, and title information included in the metadata, and generate the character UI by combining the determined prop contents.

3. The electronic device of claim 2,
wherein the processor is configured to:
control the communication device to transmit the metadata to an external server, receive character UI data corresponding to the metadata from the external server, and generate the character UI by using the received character UI data.

4. The electronic device of claim 2,
wherein the processor is configured to:
control the communication device to transmit information on the determined prop contents to an external server, and receive prop contents data corresponding to the information on the prop contents from the external server and generate the character UI.

5. The electronic device of claim 1,
wherein the communication device receives accessory information of an accessory device mounted on the electronic device, and
the processor is configured to:
determine a character shape corresponding to the accessory information, and combine the determined character shape and prop contents corresponding to the metadata and generate the character UI.

6. The electronic device of claim 5,
wherein the accessory information comprises color information of the accessory device, and
the processor is configured to:
generate the character UI such that a skin color or a background of the character shape has a color corresponding to the color information.

7. The electronic device of claim 1,
wherein the processor is configured to:
determine a guide voice mode corresponding to the generated character UI among a plurality of guide voice modes, and based on a guide message output event being generated, control the speaker such that a guide message is output in a voice corresponding to the determined guide voice mode.

8. The electronic device of claim 1,
wherein the electronic device comprises:
a sensor that detects an arrangement state of the electronic device, and
wherein the speaker is a first speaker among a plurality of speakers of the electronic device which comprise:
the first speaker which is arranged on an upper part of a main body of the electronic device, a second speaker arranged on a left side surface of the main body, a third speaker arranged on a right side surface of the main body, a fourth speaker arranged on a front surface of the main body, and a fifth speaker arranged on a bottom surface of the main body, and
the processor is configured to:
determine output modes of the first speaker, the second speaker, the third speaker, the fourth speaker and fifth speaker correspondingly to the arrangement state detected in the sensor, and control the first speaker, the second speaker, the third speaker, the fourth speaker and fifth speaker correspondingly to the determined output modes.

9. The electronic device of claim 8,
wherein the display is arranged on the upper part of the front surface of the main body, and
the fifth speaker is arranged on a lower part of the display, and
the processor is configured to:
control the display to display only an area corresponding to an arrangement form of the display on the front surface in the generated character UI.

10. The electronic device of claim 8,
wherein the processor is configured to:
check the arrangement state of the electronic device based on the sensor, and control the display to display the character UI in a direction corresponding to the checked arrangement state.

11. The electronic device of claim 1,
wherein the communication device receives information on a content that is being reproduced in the display from the display, and
the processor is configured to:
generate a character UI corresponding to the received content information, and control the display such that the generated character UI is displayed.

12. The electronic device of claim 1,
wherein the processor is configured to:
control the display to display content information corresponding to the content during reproduction of the content, and based on the reproduction of the content being stopped, or a voice instruction being input, control the display such that the character UI is displayed.

13. A control method of an electronic device, the control method comprising:
based on an instruction to reproduce a content being input, outputting a sound in association with the content;
generating a character UI in association with the content based on metadata corresponding to the content; and
displaying the generated character UI.

14. The control method of claim 13,
wherein the generating the character UI comprises:
determining prop contents to be applied to the character UI by using at least one information among genre information, singer information, and title information included in the metadata, and generating the character UI by combining the determined prop contents.

15. A computer-readable recording medium storing therein a program to execute a method of displaying a character, the method comprising:
receiving a content; and
generating a character UI in association with the content based on metadata corresponding to the content, and
the generating the character UI comprises:
determining prop contents to be applied to the character UI by using at least one information among genre information, singer information, and title information included in the metadata, and generating the character UI by combining the determined prop contents.
